(19) United States
(12) Patent Application Publication
(10) Pub. No.: US 2021/0165853 A1
(43) Pub. Date: Jun. 3, 2021

(54) DISPLAY DATA GENERATING DEVICE, DISPLAY DATA GENERATING METHOD, PROGRAM, AND PROGRAM RECORDING MEDIUM

(71) Applicant: SHARP KABUSHIKI KAISHA, Sakai City, Osaka (JP)

(72) Inventors: DAISUKE MURAYAMA, Sakai City, Osaka (JP); KEI TOKUI, Sakai City, Osaka (JP)

(21) Appl. No.: 17/262,933

(22) PCT Filed: Jul. 22, 2019
(86) PCT No.: PCT/JP2019/028637

§ 371 Date: Jan. 25, 2021

(30) Foreign Application Priority Data
Aug. 2, 2018 (JP) 2018-145799

(51) Int. Cl. G06F 17/17; G06F 5/01

(52) U.S. Cl. CPC G06F 17/17; G06F 5/01

(57) ABSTRACT

A temporal change in measurement value is clearly presented to a user. In a display data generating device, an acquisition unit sequentially acquires measurement data, and a display data generating unit generates a plurality of two-dimensional graphs corresponding to a plurality of respective points in time, based on the acquired measurement data, and generates display data by arranging, along a time series axis, the plurality of two-dimensional graphs shifted by a width according to a time difference between points in time corresponding to adjacent two-dimensional graphs.

### TECHNICAL FIELD

The present invention relates to a display data generating device, a display data generating method, a program, and a program recording medium.

This application claims the benefit of priority to Japanese Patent Application Number 2018-145799 filed in Japan on Aug. 2, 2018. The entire contents of the above-identified application are hereby incorporated by reference.

### BACKGROUND ART

Measurement is performed in various fields, and measurement values are graphed in order to clearly display a change in measurement value. For example, a shape of an object is measured and graphed, and the like. When measurement is performed for a plurality of times over time, a temporal change in measurement value can be confirmed by graphing the measurement values with one of axes as a time axis.

For example, when a temporal change is confirmed, two-dimensional graphs are generated for each measurement and are each displayed, and two-dimensional graphs for each measurement are arranged in a time axis direction to generate a three-dimensional graph. In a method in PTL 1, an oscillation displacement is measured in a width direction of a band-like body at a plurality of measurement points, and a temporal change in strain in the width direction of the band-like body is displayed by a two-dimensional graph with a time axis and an axis indicating a position in a plate width direction.

### CITATION LIST

### Patent Literature

PTL 1: JP 2015-175628 A (published on Oct. 5, 2015)

### SUMMARY OF INVENTION

### Technical Problem

However, when two-dimensional graphs are created and displayed for each measurement, the following problems occur. That is, a relationship between the two-dimensional graphs in the time axis direction is difficult to understand. Furthermore, when the measurement is performed over and over, the number of graphs increases, and this causes complicated display and time and effort required to switch display of the graph, which decreases visibility, operability, and the like.

Further, when two-dimensional graphs are arranged in the time axis direction to generate a three-dimensional graph, in particular, when many graphs are arranged in a short period, a trend of a change, a difference, and the like of the graph are difficult to understand because noise such as a measurement error is also present. Further, when a period during which no measurement is performed continues, there is a problem in that a blank portion is generated and a temporal change is difficult to understand, and the like.

Further, in the display method in PTL 1, since magnitude of a strain is expressed in the same direction as the time axis direction, there is a problem in that a relationship between the magnitude of a strain and a measurement time or the like is difficult to understand because adjacent data are overlapped and displayed.

A main object of an aspect of the present invention is to clearly present a temporal change in measurement value to a user.

### Solution to Problem

To solve the problem described above, a display data generating device according to an aspect of the present invention includes an acquisition unit configured to sequentially acquire measurement data and a generating unit configured to generate display data, wherein the generating unit is configured to generate a plurality of two-dimensional graphs corresponding to a plurality of respective points in time, based on the measurement data acquired by the acquisition unit and generate the display data by arranging, along a time series axis different from vertical and horizontal axes of each of the plurality of two-dimensional graphs, the plurality of two-dimensional graphs shifted by a width according to a time difference between points in time corresponding to adjacent two-dimensional graphs.

Further, to solve the problem described above, a display data generating method according to an aspect of the present invention includes an acquisition step of sequentially acquiring measurement data by a display data generating device and a generating step of generating display data by the display data generating device, wherein, in the generating step, the display data generating device generates a plurality of two-dimensional graphs corresponding to a plurality of respective points in time, based on the measurement data acquired in the acquisition step, and the display data generating device generates the display data by arranging, along a time series axis different from vertical and horizontal axes of each of the plurality of two-dimensional graphs, the plurality of two-dimensional graphs shifted by a width according to a time difference between points in time corresponding to adjacent two-dimensional graphs.

### Advantage Effects of Invention

According to an aspect of the present invention, a temporal change in measurement value can be clearly presented to a user.

### BRIEF DESCRIPTION OF DRAWINGS

FIG. 1 is a block diagram illustrating a configuration of a display data generating device according to a first embodiment.

FIG. 2 is a diagram illustrating an example of a subject when the amount of wear is measured, according to the first embodiment.

FIG. 3 is a diagram illustrating an example of display data according to the first embodiment.

FIG. 4 is a diagram illustrating details of display data according to the first embodiment.

FIG. 5 is a flowchart illustrating an example of a flow of processing of the display data generating device according to the first embodiment.

FIG. 6 is a flowchart illustrating an example of a flow of axis configuration processing by an axis configuration unit according to the first embodiment.

FIG. 7 is a diagram illustrating display data when a first measurement value is acquired, according to the first embodiment.

FIG. 8 is a diagram illustrating display data when a measurement is performed for a plurality of times after a time period has elapsed since a point in time in FIG. 7 according to the first embodiment.

FIG. 9 is a diagram illustrating display data when a measurement is performed for a plurality of times after a time period has elapsed since a point in time in FIG. 8 according to the first embodiment.

FIG. 10 is a block diagram illustrating a configuration of a display data generating device according to a second embodiment.

FIG. 11 is a diagram illustrating a specific example of display data according to a first modification of the first and second embodiments.

### DESCRIPTION OF EMBODIMENTS

Each of embodiments of the present invention will be described in detail below with reference to the drawings. However, a configuration described below is not intended to limit the scope of the embodiments of the present invention to its only extent unless otherwise specified, and is merely an explanatory example. Further, each of the drawings is used for description and is not intended to limit the present invention.

### First Embodiment

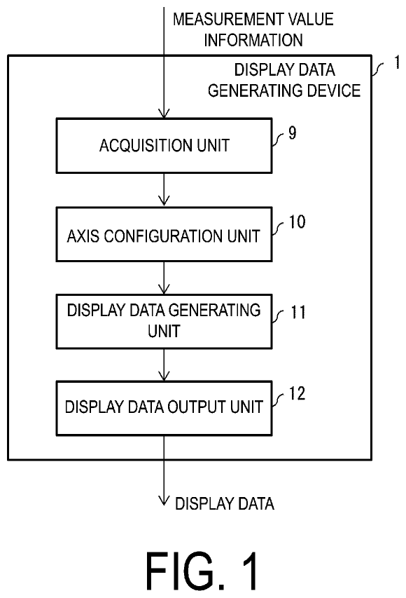

A display data generating device according to a first embodiment will be described below with reference to FIGS. 1 to 9.

### Display Data Generating Device 1

FIG. 1 is a block diagram illustrating a configuration of a display data generating device 1 according to the present embodiment. The display data generating device 1 includes an acquisition unit 9, an axis configuration unit (generating unit) 10, a display data generating unit (generating unit) 11, and a display data output unit 12. The acquisition unit 9 sequentially acquires a measurement value (measurement data). The display data generating unit 11 generates a plurality of two-dimensional graphs corresponding to a plurality of respective points in time, based on the measurement value acquired by the acquisition unit 9, and generates display data by arranging, along a time series axis different from vertical and horizontal axes of the two-dimensional graph, the plurality of two-dimensional graphs being obliquely shifted by a width according to a time difference between points in time corresponding to adjacent two-dimensional graphs. According to the configuration, a temporal change in measurement value can be clearly presented to a user.

The display data generating device 1 acquires measurement value information, and generates and outputs display data, based on the measurement value information. The measurement value information includes information needed for generating display data, such as information indicating a measurement value and a timing at which a measurement value is measured such as measurement date and time, and information indicating an acquired position of a measurement value. Further, the measurement value information is acquired by being output from a measurement device, read from a storage medium, or transmitted through a network. The display data is a graph expressed in three dimensions and will be described in detail below. The generated display data is output as a video signal to a display or stored as an image file in a storage medium.

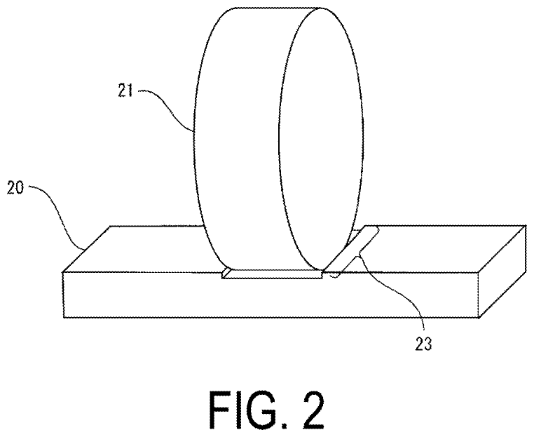

In the present embodiment, an example of graphing and displaying, as a measurement value, a change (amount of wear) in shape of an object including a sliding portion being gradually worn away will be described. FIG. 2 is a diagram illustrating an example of a subject when the amount of wear is measured, according to the present embodiment.

FIG. 2 illustrates objects 20 and 21 that slide and a sliding portion 23 located therebetween. The object 20 is a measurement subject. The object 21 slides in a depth direction while being displaced in a left-right direction in FIG. 2, and thus a surface of the object 20 is gradually worn away. When the amount of wear is greater than a threshold value configured in advance, the object 20 is replaced and returns to a state without wear.

Note that the measurement value is not limited to the amount of wear of a wear object, and may be a value that changes over time. In other words, the measurement value may be any measurement value as long as the measurement value can be graphed and displayed, and a measured numerical value, a fluctuation situation thereof, and the like can thus be intuitively confirmed by the user.

For example, when an increase in thickness of a subject is measured in a case where a coating is applied or earth and sand are accumulated, when a deviation, a strain, and the like from a reference of an object shape are measured, when a position, a speed, and the like of a moving object are measured, when a strain, an inclination, a vibration, and the like of a building are measured, when a change in atmospheric temperature, temperature, heat, or the like is measured, when a frequency, an amplitude, and a phase are measured such as case in which a voice or a vibration of a bridge is measured, when a body is measured, such as a case where a body temperature, a heart rate, weight, or a tumor size is measured, when a growth (such as size and weight) of animals or plants is measured, and the like, various measurement subjects are conceivable.

Note that the display data generating device 1 according to the present embodiment can be achieved by software processing by a Central Processing Unit (CPU), a Graphics Processing Unit (GPU), and the like. Further, the display data generating device 1 according to the present embodiment can be achieved by hardware processing by an Application Specific Integrated Circuit (ASIC), a Field Programmable Gate Array (FPGA), and the like.

An overview of display data and an overview of the axis configuration unit 10, the display data generating unit 11, and the display data output unit 12 that constitute the display data generating device 1 will be described below. Next, a flow of the entire processing and details of each processing will be described.

### Overview of Display Data

Display data is a graph expressed by three axes (three dimensions), and is generated by the display data generating unit 11, which will be described later.

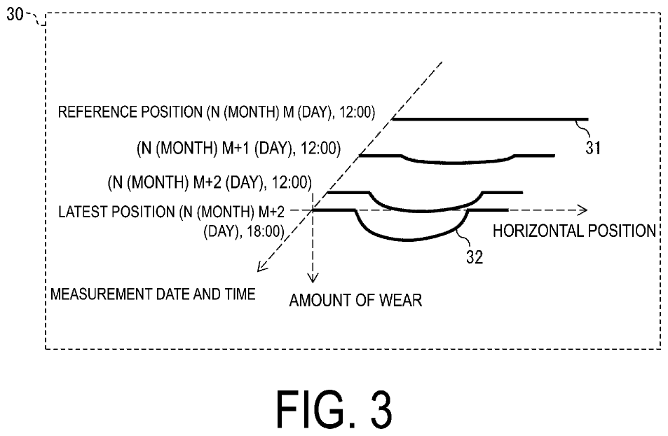

FIG. 3 is a diagram illustrating an example of display data according to the present embodiment. FIG. 3 illustrates an example of the display data when the amount of wear of the object illustrated in FIG. 2 is measured. In FIG. 3, a vertical axis indicates the amount of wear (wear direction), a horizontal axis indicates a horizontal position (horizontal direction) on an object, and an axis (time series axis) in a depth direction indicates the measurement date and time (time direction). FIG. 3 illustrates a situation where a total of four of a straight line and curved lines based on measurement values measured at different points in time are arranged side by side in the depth direction (time direction).

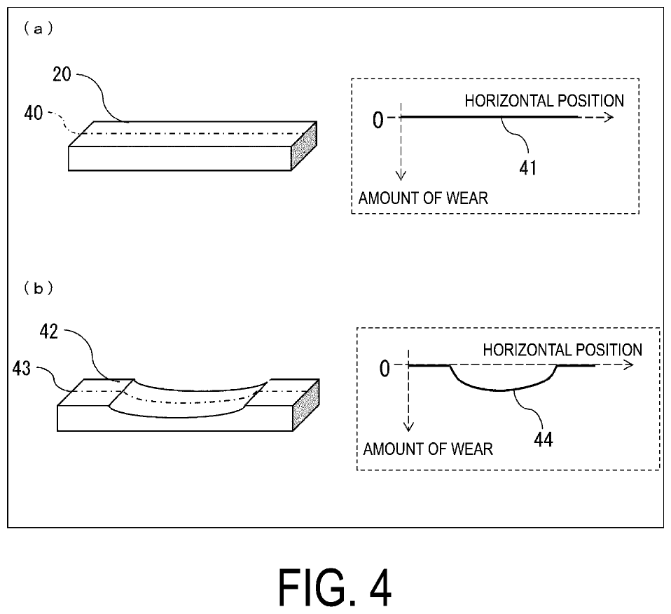

A graph 31 is a measurement result of the object 20 at a point in time (reference position) being a reference of display. FIG. 4 is a diagram illustrating details of display data according to the present embodiment. The object 20 illustrated in FIG. 4(a) represents an object without wear.

On the other hand, a graph 32 illustrated in FIG. 3 is a latest measurement result of the object 20, and illustrates a situation where the amount of wear is greater than that of the graph 31 being the reference position. An object 42 illustrated in FIG. 4(b) represents an object with a greater amount of wear.

Further, as illustrated in FIG. 3, a graph is also displayed in a position at a regular interval from the reference position between the reference position and the latest position, and a situation where the amount of wear gradually increases is illustrated.

In FIG. 4, a dot-dash line 40 and a dot-dash line 43 each represent a measurement position on an object, and a graph 41 and a graph 44 are each acquired by graphing three-dimensional information about the measurement position. With regard to the graphs 41 and 44, a vertical axis indicates the amount of wear (wear direction), and a horizontal axis indicates a horizontal position (horizontal direction) on an object. The graph 41 indicates a situation without wear of the object by a straight line. The graph 44 indicates a curved line according to the amount of wear of the object. The display data is acquired by arranging graphs generated on the basis of measurement values at the respective points in time, such as the graph 41 and the graph 44, along the time series axis different from the vertical and horizontal axes of the graph.

### Axis Configuration Unit 10

The axis configuration unit 10 configures a display position on a time series axis, such as the measurement date and time axis illustrated in the display data example in FIG. 3. Details of a content and a method of axis configuration will be described later. In the present embodiment, the time series axis is disposed diagonally with respect to the vertical axis and the horizontal axis of the graph. However, when display data output by the data generating device 1 is three-dimensionally displayed by a three-dimensional display device that enables three-dimensional display, the time series axis may be an axis orthogonal to the vertical axis and the horizontal axis of the graph.

### Display Data Generating Unit 11

The display data generating unit 11 generates a graph corresponding to a display position, based on measurement value information and axis configuration information acquired from the axis configuration unit 10, and generates display data by arranging each graph. Details of display data and a method for generating the display data will be described later.

### Display Data Output Unit 12

The display data output unit 12 outputs display data generated by the display data generating unit 11.

### Processing of Display Data Generating Device 1

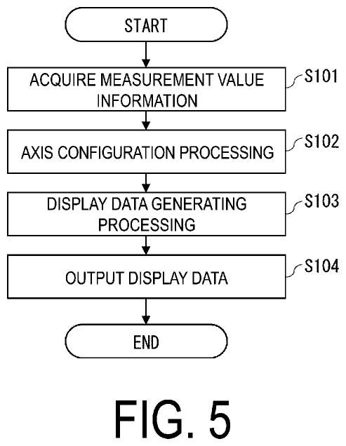

Next, a flow of processing of the display data generating device 1 according to the present embodiment will be described with reference to FIG. 5. FIG. 5 is a flowchart illustrating an example of the flow of the processing of the display data generating device 1 according to the present embodiment.

FIG. 5 illustrates the flow of the processing of the display data generating device 1 with respect to measurement value information acquired at single measurement. In other words, the processing illustrated in FIG. 5 is performed each time measurement is performed and the display data generating device 1 acquires measurement value information. Note that, when there are a plurality of pieces of measurement value information measured at different points in time, the pieces of measurement value information are successively acquired by the display data generating device 1 and can thus be processed according to the flow of FIG. 5.

### Step S101

In the display data generating device 1, the acquisition unit 9 acquires measurement value information generated at the single measurement. The axis configuration unit 10 and the display data generating unit 11 use the measurement value information.

### Step S102

The axis configuration unit 10 configures a display position on a time series axis, based on the acquired measurement value information, and outputs axis configuration information indicating the display position on the axis to the display data generating unit 11. Details of a content and a configuration method of axis configuration information will be described later.

### Step S103

The display data generating unit 11 acquires the measurement value information and the axis configuration information, and generates display data, based on the pieces of information. Details of display data and a method for generating the display data will be described later.

### Step S104

The display data output unit 12 acquires the display data from the display data generating unit 11, and outputs the display data.

The display data generating device 1 performs axial configuration, based on acquired measurement value information, and further generates and displays display data according to the processing procedure described above. The display data is a three-dimensional graph in which two-dimensional graphs are arranged in appropriate positions in the time direction. Therefore, in a case where the user visually recognizes display data, the user can intuitively and easily confirm a temporal change in measurement value.

### Details of Axis Configuration Processing

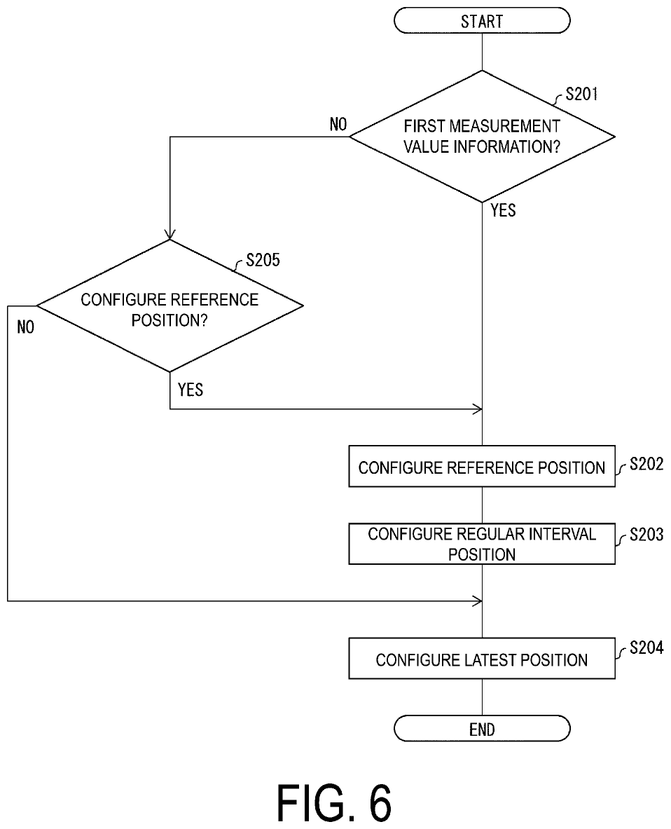

FIG. 6 is a flowchart illustrating an example of a flow of axis configuration processing by the axis configuration unit 10 according to the present embodiment. The flow of the axis configuration processing will be described with reference to FIG. 6.

### Step S201

The axis configuration unit 10 determines whether an acquired measurement value is a first measurement value (there is no prior measurement value). When the acquired measurement value is a first measurement value (YES in step S201), the axis configuration unit 10 executes step S202. When the acquired measurement value is a second or subsequent measurement value, the axis configuration unit 10 executes step S205.

### Step S202

The axis configuration unit 10 configures a point in time at which the acquired measurement value is measured to a reference position. The reference position is one of display positions on the time series axis. For example, the axis configuration unit 10 configures a new reference position regardless of previous regular intervals. It is assumed that an interval to the new reference position is an interval according to a time interval to the new reference position.

### Step S203

The axis configuration unit 10 configures, as a regular interval position (regular interval point in time), a position at a regular interval from the reference position. Each of the regular interval positions is a display position on the time series axis. The axis configuration unit 10 configures the regular interval position at a 24-hour time interval from the reference position, i.e., a point in time every 24 hours such as 24 hours, 48 hours, and . . . from the reference position, for example.

For example, when a change in a measurement subject within 24 hours is small, it can be said that it is sufficient to display a measurement result at intervals of 24 hours, and thus a position at a 24-hour time interval is configured. In this way, a measurement result is not excessively displayed, which is suitable.

Here, the configuration of a regular interval position is not limited to the method described above, and the user can freely configure a regular interval position. It is suitable to configure a regular interval position, that is, the number of graphs, such that a temporal change can be sufficiently confirmed by display data and a decrease in visibility due to excessive display of a graph is prevented, in consideration of a measurement period, the number of measurement times, how a measurement value fluctuates, a size and resolution of a display as an output destination of the display data output unit 12, and the like. Further, the display data generating device 1 may automatically configure a regular interval position, based on a time interval of previously input measurement value information, resolution of video or an image to be output, and the like. The automatic configuration of a regular interval position allows display data to be generated on the basis of a measurement frequency, a display environment, and the like, a graph in which a temporal change can be intuitively and easily confirmed to be presented, and a configuration operation of the user to be reduced.

Further, a regular interval position may be configured in a range where the user can feel a regular interval. For example, in the example described above, each interval may not be exactly 24 hours, and it does not matter that each interval is shifted by several seconds. In other words, the display position may be appropriately configured at substantially regular intervals depending on the resolution of the display output with display data, a range in the time direction in which measurement value information is displayed, or the like.

Note that, when display data is larger than a screen size, a part of the display data that fits within the screen may be displayed, or an interval may be compressed such that the entire display data fits within the screen.

### Step S204

The axis configuration unit 10 configures, as a latest position, a measurement point in time of the acquired measurement value. The latest position is a display position on the time series axis. In this way, the user can always confirm a latest measurement result. Note that, when a current measurement point in time is configured as the reference position in step S202, the reference position and the latest position are the same. Further, the axis configuration unit 10 controls the display position such that the latest data is displayed at all times. Thus, the latest position is fixed, and past data shifts upwardly and diagonally.

### Step S205

The axis configuration unit 10 determines whether to newly configure the reference position, based on the acquired measurement value. When the reference position is newly configured as a result of the determination (YES in step S205), the axis configuration unit 10 executes step S202. When the reference position is not newly configured (NO in step S205), the axis configuration unit 10 executes step S204. When the axis configuration unit 10 does not newly configure the reference position, both the reference position and the regular interval position remain the same as those in the previous configuration.

The axis configuration unit 10 configures a reference position (reference point in time), based on a change in measurement value acquired by the acquisition unit 9. According to the configuration, replacement of a measurement subject can be estimated according to a change in measurement value, and thus a new reference position can be configured.

When the axis configuration unit 10 determines whether to newly configure a reference position, the axis configuration unit 10 compares a previous measurement value with a current measurement value, and determines whether the change coincides with a predetermined determination criterion. For example, in the example of measuring the amount of wear of the object illustrated in FIG. 2, when a previous amount of wear is greater than a previously configured threshold value and a current amount of wear is less than the threshold value, the axis configuration unit 10 determines a reference position such that a current measurement point in time is configured as a new reference position. This is based on a fact that a sudden reduction (or elimination) after the amount of wear gradually increases occurs when a measurement subject is replaced. In a case where determination is performed in such a manner, in the example illustrated in FIG. 2, a measurement point in time immediately after an object to be measured is replaced can be configured as a reference position.

When a measurement subject is replaced as in the example in FIG. 2, it can be said that information at a replacement point in time and a temporal change in measurement value from the replacement point in time are particularly important information. Therefore, in a case where the replacement point in time is configured as a reference position, a change from the replacement point in time can be confirmed at each replacement, which is suitable. Note that, when a determination is performed according to magnitude of a measurement value as described above, the determination can be performed with the exclusion of an error by configuring a change greater than a measurement error as a determination criterion, which is suitable.

Here, a determination of new reference position configuration is not limited to the method described above. For example, the axis configuration unit 10 may determine whether a current measurement point in time is a configured timing by periodically configuring a reference position. Further, by determining a case where there is a sudden change due to an error and the like, the axis configuration unit 10 may perform a determination so as to configure a new reference position next time after the change. A criterion for performing a determination may be provided as appropriate for a case where a measurement value is an abnormal value, such as a case where a great inclination, a great strain, or the like occurs.

Further, the axis configuration unit 10 may fix a first measurement point in time as a reference position without configuring a new reference position. It is desirable that the axis configuration unit 10 configures a reference position such that the most important measurement period is included in a display position according to a measurement subject, and it is suitable that the axis configuration unit 10 determines a new reference position configuration so as to achieve the configuration of the reference position.

Further, the method in a case where the axis configuration unit 10 stores a reference position is described in the processing described above. However, when measurement value information is acquired, the axis configuration unit 10 may search for past measurement value information, and configure measurement value information that satisfies a condition as a reference position. For example, the axis configuration unit 10 confirms a state of a measurement value from latest measurement value data in order from closest date and time, and configures, as a reference position, a measurement point in time immediately after a measurement point in time at which a measurement value is equal to or greater than a threshold value (one measurement point in time before in a confirming order). In other words, in a case where a measurement value is the amount of wear, an object to be measured is replaced when the measurement value is equal to or greater than a threshold value, and thus a reference position can be configured immediately after the replacement.

According to the above-described processing procedure, the axis configuration unit 10 configures a display position on the time series axis. In other words, the axis configuration unit 10 configures, as axis configuration information, a reference position, a regular interval position, and a latest position that are positions where graphs are displayed on display data. Note that a new display position at a measurement point in time is configured on a near side of display data. In this way, a measurement result of a position where the most important range is divided at an appropriate interval and a latest measurement result can be displayed as display data according to a measurement subject, and thus the user can intuitively and easily confirm a temporal change in measurement value. Further, since a new measurement result is always displayed on the near side, the user can easily confirm a latest state, which is suitable.

Here, when two or more reference positions are configured, the axis configuration unit 10 generates a two-dimensional graph corresponding to a range including at least two new reference positions among the two or more reference positions. According to the configuration, a series of changes from a previous reference position to a current reference position can be presented.

Specifically, a range of an axis and an interval between display positions can be freely configured, and thus the axis configuration unit 10 configures axis configuration information according to a size and resolution of a display as an output destination of the display data output unit 12, and a display size of display data. In this case, it is suitable to display a graph in a necessary period according to a measurement subject and configure the axis configuration information such that a decrease in visibility as a result of which display positions (graphs) are too close or separate is prevented. Further, when the measurement subject is replaced as in FIG. 2, a change from the replacement point in time can be confirmed by configuring a range of an axis and an interval between display positions such that at least a previous reference position is always included in the display position, which is suitable. Furthermore, when a new reference position is configured, a series of changes from a previous reference position to a current reference position can be confirmed by performing configuration such that the previous reference position is included in a display position, which is suitable.

Note that the time series axis is measurement time in the example described above; however, no such limitation is intended. For example, in the case of the example in FIG. 2, the amount of wear increases in accordance with a movement distance (amount of sliding) of the object, and thus an axis indicating the movement distance may be used instead of the time series axis. In addition, a method for configuring the number of measurement times, the number of use times, a data number, an elapsed time from a certain point in time, or the like is conceivable. It is suitable to configure an axis such that important information and a temporal change thereof are clearly displayed according to a measurement subject.

Further, in the example described above, as illustrated in FIG. 3, a graduation on the time axis is configured as a linear change (change according to an arithmetic progression), but configuration of a graduation is not limited thereto. For example, when the number of measurement times increases over time and the like, it is suitable to configure a graduation of the time axis, based on a logarithmic change, and display a two-dimensional graph for each measurement in a state in which the two-dimensional graphs are arranged at a constant interval. In other words, a graduation of the time series axis can be configured according to intervals that change according to a certain rule, such as an arithmetic progression, a geometric progression, a logarithm, and an exponential change, and it is desirable to perform configuration such that a temporal change is most clearly displayed, based on a measurement period, the number of measurement times, and the like.

Note that a regular interval position is configured on the time axis in which the graduation is configured as described above. A regular interval position may be configured so as to be a linearly changing position on the axis regardless of a change in graduation, or a regular interval position may be configured in a position that changes according to a change in graduation.

### Details of Display Data Generating Processing

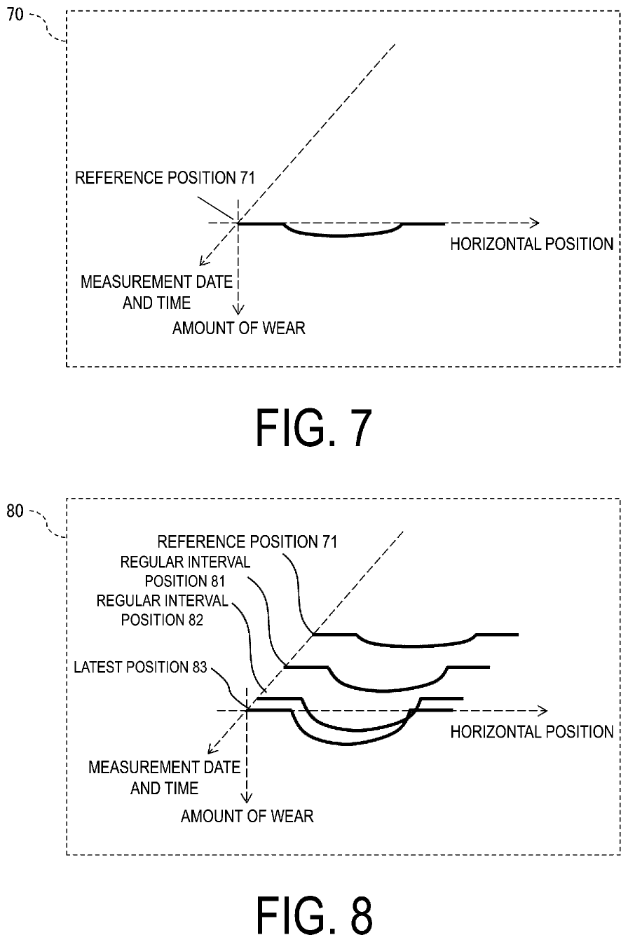

In step S103 in FIG. 5, the display data generating unit 11 generates display data, based on the acquired measurement value information and the acquired axis configuration information. Details of the display data and a method for generating the display data will be described below by using FIGS. 7 to 9.

The display data generating unit 11 generates a two-dimensional graph corresponding to each display position configured by the axis configuration unit 10, based on a measurement value. The graph is, for example, a two-dimensional graph representing a fluctuation in measurement value as illustrated in the graph 41 and the graph 44 in FIG. 4. A vertical axis of the graph is an axis indicating a change in measurement value. A horizontal axis of the graph is an axis configured according to a measurement content, such as a measurement position.

When the acquisition unit 9 has not acquired a measurement value in a regular interval position, the display data generating unit 1 generates a graph (regular interval two-dimensional graph) corresponding to the regular interval position, based on data interpolated from a measurement value at a point in time around the regular interval position. According to the configuration, even when a measurement value in a certain regular interval position is not acquired, a graph corresponding to the regular interval position can be generated.

A regular interval position configured by the axis configuration unit 10 is a position configured at a predetermined interval from a reference position. However, it is also assumed that there is no measurement value in the position (at the point in time). Thus, a measurement value in each display position is interpolated on the basis of a measurement value measured at a point in time within a predetermined range around each display position. A measurement value is interpolated by a known technique such as nearest neighbor interpolation, linear interpolation, and spline interpolation. The intensity of smoothing in the time direction changes according to a configuration of a predetermined range around a display position. Thus, to prevent excessive smoothing, the predetermined range is appropriately configured according to an interpolation technique. In a case where a measurement value is interpolated and calculated in such a manner, a slight change such as a measurement error is smoothed and visibility is improved, which is suitable.

Note that, when there is a measurement value measured at a point in time in a display position, the display data generating unit 11 does not necessarily need to interpolate the measurement value, and, even when the measurement value is used as is, the effect of improving visibility is acquired. Further, the display data generating unit 11 may use, as a measurement value at a point in time in a display position, an averaged value of a measurement value at a point in time in the display position and a measurement value around the measurement value at the point in time in the display position. Furthermore, when a latest measurement value is acquired, the display data generating unit 1 may regenerate a graph in another display position, which has already been generated before a previous time. In this way, each time a measurement value is acquired, data that can be used for interpolation increases, and thus the display data generating unit 11 can calculate a more appropriate interpolation value. However, when throughput applied to graph generation is desired to be reduced and the like, the display data generating unit 11 may hold data about a graph that has been generated once, and use the data next and subsequent times.

Further, for example, as illustrated in FIG. 3, the display data generating unit 11 configures the time series axis in the display data such that a direction of the time series axis is the depth direction of the diagram at an angle different from those of the vertical axis and the horizontal axis of the graph.

Subsequently, the display data generating unit 11 generates the display data by arranging each generated graph in each display position of the configured time series axis. The display data generating unit 11 generates a graph (reference two-dimensional graph) corresponding to at least one reference position and a graph (regular interval two-dimensional graph) corresponding to a regular interval position with time put forward by a regular interval from each reference position within a range of not exceeding another reference position. According to the configuration, a temporal change in measurement value from a reference position can be clearly presented to the user.

An example of display data will be described below by taking, as an example, a case where the amount of wear of the object illustrated in FIG. 2 is measured.

FIG. 7 is a diagram illustrating display data 70 when a first measurement value according to the present embodiment is acquired. A reference position 71 and a graph corresponding to the position are displayed in the display data 70 in FIG. 7. At this time, the reference position 71 is equal to a latest position.

FIG. 8 is a diagram illustrating display data when measurement is performed for a plurality of times after a time period has elapsed since a point in time in FIG. 7. In display data 80 in FIG. 8, there is the reference position 71 in a position moved in a direction opposite to the measurement date and time direction from the position of the reference position 71 in FIG. 7, and a graph corresponding to each position of a regular interval position 81, a regular interval position 82, and a latest position 83 is displayed. In other words, a graph is generated such that an interval in the time axis direction between the reference position 71 and the regular interval position 81 and an interval in the time axis direction between the regular interval position 81 and the regular interval position 82 are regular intervals.

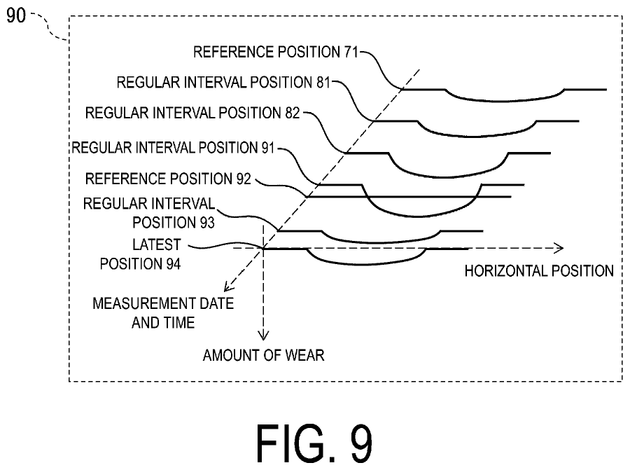

FIG. 9 is a diagram illustrating display data when measurement is performed for a plurality of times after a time period has elapsed since a point in time in FIG. 8. In display data 90 in FIG. 9, a graph corresponding to each position of the reference position 71, the regular interval position 81, the regular interval position 82, a regular interval position 91, a reference position 92, a regular interval position 93, and a latest position 94 is displayed. The reference position 71 gradually moves toward the back side of the drawing in order of FIGS. 7, 8, and 9. As illustrated in FIGS. 8 and 9, a graph of a new measurement value is always displayed on the near side, and a graph of an old measurement value moves toward the back side and is displayed. Since the reference position 92 that is a latest reference position is configured, the reference position 71 that is the reference position in FIG. 8 is no longer a reference for a regular interval position to be newly configured. In other words, a regular interval position after the reference position 92 is configured is configured as a regular interval position from the reference position 92. The reference position 92 is in a position in which a measurement subject is replaced because of the increased amount of wear. Further, a graph is generated such that an interval in the time axis direction between the regular interval position 81 and the regular interval position 82, an interval in the time axis direction between the regular interval position 82 and the regular interval position 91, and an interval in the time axis direction between the regular interval position 91 and the regular interval position 93 are regular intervals.

Here, when a reference position is newly configured, the axis configuration unit 10 cancels the reference position that has already been configured, and also generates a graph (second regular interval two-dimensional graph) corresponding to a regular interval position (second regular interval point in time) with time put back by a regular interval from the newly configured reference position. According to the configuration, an interval between past regular interval positions and an interval between regular interval positions after a reference position is configured is equal, and thus a trend of change with time can be clearly presented.

Specifically, when the reference position 92 is configured, the axis configuration unit 10 may reconfigure a past regular interval position. For example, an effect in which a trend of change with time can be clearly presented is also obtained by a method in which when the reference position 92 is configured in FIG. 9, the axis configuration unit 10 also configures a regular interval position in a position at a regular interval in the time axis direction to old data with reference to the reference position 92, and display data is generated.

In other words, in a case where a regular interval position that has already been configured with reference to a past reference position is not changed even when a reference position is reconfigured, an effect in which data about the regular interval position does not need to be recalculated can be obtained. Further, when a regular interval position configured with reference to a past reference position is reconfigured with reference to a latest reference position, an effect can be obtained in which an interval between the past regular interval positions and an interval between regular interval positions after the reference position is configured is equal, and a trend of change with time can be more easily confirmed.

Further, in the method described above, the display position of the latest position 94 is fixed and displayed, but another position may be fixed. For example, a latest regular interval position (a latest reference position in a case where the latest regular interval position does not exist) that is a position of the regular interval position 93 in FIG. 9 may be fixed, a display position of latest data may be gradually moved, and the entire position may be moved by a regular interval when a next regular interval position is configured. Note that an intermediate position of the entire display data may be fixed.

Furthermore, in FIGS. 7, 8, and 9, measurement value information configured as the reference position is output as one or two pieces of display data, but when a time series range of the display data is shorter than an updating period of the reference position, there is also a case where the measurement value information of the reference position is not included. Therefore, when the time series range of the display data is configured longer than the updating period of the reference position, a current state can be confirmed as a change from the reference position, which is suitable. In other words, suitable display data can be generated by configuring a time series range of display data, based on a standard replacement cycle of a measurement subject and the like.

As described above, the display data generating unit 11 generates display data by generating and arranging a graph corresponding to each display position configured by the axis configuration unit 10. In this way, display data in which a plurality of graphs arranged along a time series are viewed obliquely from above is generated, and thus the user can intuitively and easily confirm a temporal change in measurement value.

In the present embodiment, a case where the display data is constituted as illustrated in FIGS. 7, 8, and 9 is described, but the display data may be display data including the graph as in FIGS. 7, 8, and 9. The display data may also be display data including basic data such as, for example, a model number of a measurement subject, an image, an installation place, an appearance, a design value, a determination criterion of a reference position, and a configuration value of a regular interval. Furthermore, the display data may also be display data including a configuration function capable of manually configuring a configuration value of a regular interval, a determination criterion of a reference position, and the like.

### Effect of First Embodiment

As described above, the display data generating device 1 according to the present embodiment performs axis configuration, based on input measurement value information, and generates and outputs display data, based on measurement value information and axis configuration information.

In this way, display data in which a plurality of graphs arranged along a time series are viewed obliquely from above is generated, and thus the user can intuitively and easily confirm a temporal change in measurement value, which is suitable. Further, since a reference position is configured according to a measurement subject and a graph of a measurement value is displayed in a position at a regular interval from the reference position, a temporal change in measurement value in a necessary range can be confirmed while preventing a decrease in visibility as a result of which the graphs are too close or separate when the number of measurement times greatly changes within a certain period. Furthermore, since a graph of a latest measurement value is always displayed on the near side, a latest measurement result can be easily confirmed, which is suitable.

Note that, in the example described above, two-dimensional graphs are displayed side by side in the time axis direction, but mesh display in which corresponding points of the graphs are connected may be further used. In this case, for example, a mesh can be created by interpolating a measurement value between display positions from a measurement value in a corresponding position. In a case of using the mesh display, there is an effect in which the corresponding position of the graph at each point in time is easy to understand.

### Second Embodiment

The display data generating unit 11 of the display data generating device 1 according to the first embodiment interpolates a measurement value in each display position, based on a measurement value in a range around the display position.

In a display data generating device 2 according to a second embodiment, a display data generating unit 200 determines whether the amount of change in measurement value is less than a threshold value for the respective pieces of data adjacent in front and back within a predetermined range (interpolation range) around a display position in the time series direction for each display position, and interpolates a measurement value, based on only a measurement value whose amount of change is less than the threshold value. Further, when a measurement is performed at a point in time of a display position, the display data generating unit 200 uses a measurement value as is without interpolation.

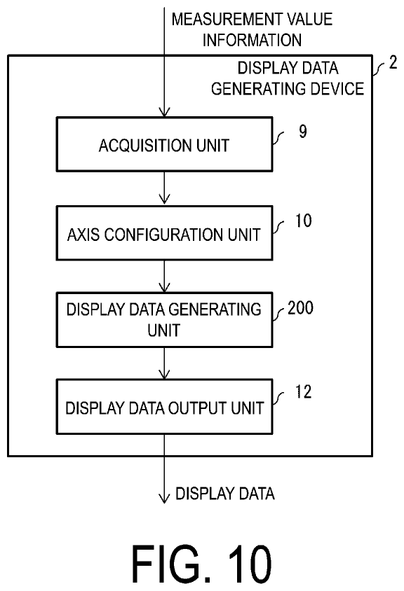

The display data generating device 2 according to the present embodiment will be described below. FIG. 10 is a block diagram illustrating a configuration of the display data generating device 2 according to the present embodiment. As illustrated in FIG. 10, the display data generating device 2 has a configuration in which the display data generating unit 11 of the display data generating device 1 is replaced with the display data generating unit 200. Components having the same function as that of the components described in the first embodiment are denoted by the same reference signs, and the description thereof will be herein omitted.

The display data generating unit 200 differs from the display data generating unit 100 of the display data generating device 1 in operation when a measurement value in a display position is interpolated. Note that the display data generating unit 200 uses a known interpolation technique similarly to the display data generating unit 11.

By taking the display data illustrated in FIG. 9 as an example, interpolation processing of a measurement value in the display data generating unit 200 will be described. In this example, an interpolation range is configured between front and back regular interval positions, and a maximum amount of change that may occur between pieces of data adjacent in a time direction is configured as a threshold value of a change in measurement value.

First, with regard to the reference positions 71 and 92 and the latest position 94 illustrated in FIG. 9, a measurement is performed at a point in time thereof, and thus the display data generating unit 200 uses a measurement value as it is without performing the interpolation processing.

The display data generating unit 200 interpolates a measurement value in the regular interval position 81, based on a measurement value measured between the reference position 71 and the regular interval position 82. The display data generating unit 200 interpolates a measurement value in the regular interval position 82, based on a measurement value between the regular interval positions 81 and 91. The display data generating unit 200 interpolates a measurement value in the regular interval position 91, based on a measurement value between the regular interval position 82 and the reference position 92.

When the display data generating unit 200 interpolates data from a measurement value in a position (at a point in time) around a regular interval position, the display data generating unit 200 does not use a measurement value in a position configured across a reference position from the regular interval position. According to the configuration, a measurement value in a position configured across a reference position from the regular interval position is not used, and thus inappropriate interpolation can be suppressed in a period in which a change in measurement value is great.

Specifically, since the measurement value in the reference position 92 changes to be equal to or greater than a threshold value from those in positions before and after the point in time of the reference position 92, the display data generating unit 200 does not use the measurement value for interpolation. The display data generating unit 200 interpolates a measurement value in the regular interval position 93, based on a measurement value between the reference position 92 and the latest position 94.

As described above, the display data generating unit 200 interpolates a measurement value, based on a measurement value that changes to be less than a threshold value within an interpolation range.

### Effect of Second Embodiment

As described above, even when a measurement subject is replaced, the display data generating device 2 according to the present embodiment can prevent a measurement value from being smoothed in a period around the replacement, and can clarify a change in a reference position. Further, even when a measurement error occurs and only the measurement value at a certain point in time greatly changes, interpolation can be achieved with the exclusion of the measurement value of the error. Therefore, display data is generated by a graph based on a more correctly interpolated measurement value, and thus the user can confirm a temporal change with a more correct measurement result, which is suitable.

### First Modification

When display data generated by the display data generating device 1 according to the first embodiment and the display data generating device 2 according to the second embodiment is generated by a method described below, the display data in which a change in a reference position is easily visually recognized can be generated. The following processing may be performed by any of the display data generating unit 11 of the display data generating device 1 and the display data generating unit 200 of the display data generating device 2.

The display data generating unit 11 or 200 according to the first modification generates display data in which a two-dimensional graph corresponding to a new point in time on the time series axis is preferentially displayed. According to the configuration, visibility of a two-dimensional graph corresponding to a new point in time can be improved.

In the display data generated by the display data generating devices 1 and 2, when the amount of wear indicated by a graph on the back side is greater than the amount of wear indicated by a graph on the near side, the graphs are displayed in an overlapping manner. For example, in FIG. 9, the graph in the regular interval position 91 and the graph in the reference position 92 are displayed in an overlapping manner. In other words, there is a case where a fluctuation in old measurement value is great on the time series axis, and the graph overlaps a graph of a new measurement value.

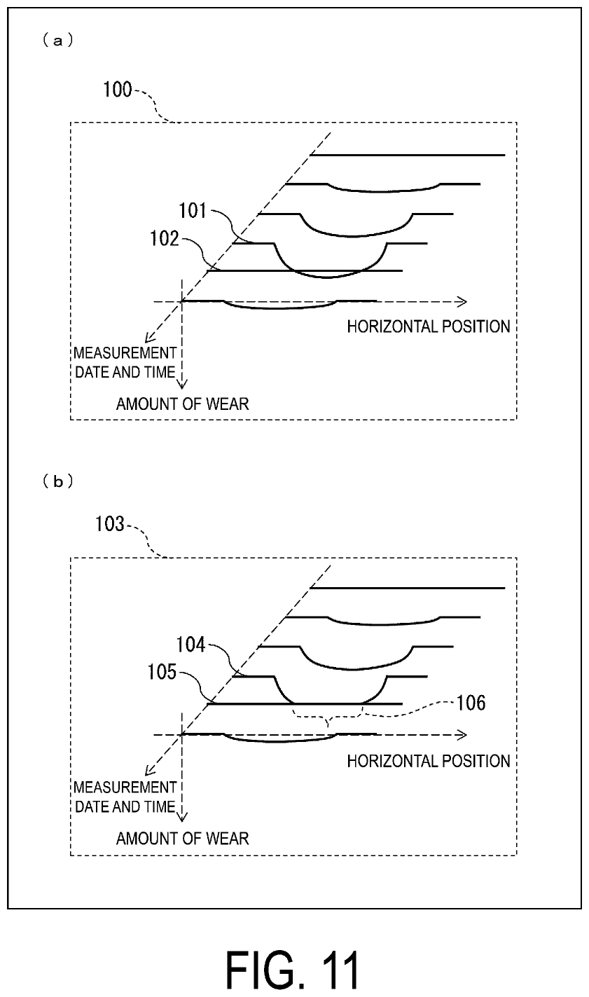

In the first modification, in the case as described above, an overlapping range of an old measurement value is not displayed in display data. FIG. 11 is a diagram illustrating a specific example of display data according to the first modification. As illustrated in FIG. 11(a), a graph 101 and a graph 102 overlap each other in display data 100. As illustrated in FIG. 11(b), in display data 103 generated by the present modification, a range 106 in which a graph 104 and a graph 105 overlap with each other is not displayed.

### Effect of First Modification

As described above, in the present modification, when display positions of graphs overlap with each other on display data, the display data generating device 1 or the display data generating device 2 does not display an overlapping range of an old measurement value. In this way, visibility of a graph of a new measurement value is improved, which is suitable. Note that making an overlapping range of an old measurement value inconspicuous by a method by, instead of not completely displaying the overlapping range of the old measurement value, indicating the overlapping range with a broken line, making a thickness of a line thin, making density of a color low, and the like also contributes to an improvement in visibility of a graph of a new measurement value.

### Second Modification

When display data generated by the display data generating device 1 according to the first embodiment and the display data generating device 2 according to the second embodiment is generated by a method described below, the display data having greater visibility can be generated. The following processing may be performed by any of the display data generating unit 11 of the display data generating device 1 and the display data generating unit 200 of the display data generating device 2. Further, the processing described in the first modification may be performed in combination.

The display data generating unit 11 or 200 according to a second modification configures a different color for each two-dimensional graph according to data indicated by the two-dimensional graph. According to the configuration, a situation of data can be determined from a color of a two-dimensional graph, and thus a temporal change in measurement value can be more clearly presented.

In the second modification, a drawing color of a graph is changed according to magnitude of a fluctuation in measurement value. When the amount of wear of the object illustrated in FIG. 2 is measured, for example, a drawing color of a graph is configured so as to become more red as the amount of wear increases and to become more blue as the amount of wear decreases. In this way, since magnitude of the amount of wear can be determined from information about a color, a content of display data can be more easily confirmed, which is suitable.

Further, as in the example in FIG. 2, in a case where a measurement subject is replaced when the amount of wear of the measurement subject reaches a limit, a drawing color may be configured in accordance with a difference between a threshold value and a measurement value. In this way, since information about a color indicates that the amount of wear increases and the time for replacement is approaching, the user can intuitively perform a determination, which is suitable. Configuration of a color is not limited thereto, and it is desirable to perform configuration such that a change in measurement value is intuitively easy to understand according to a measurement subject.

Note that, in addition to configuration of a color, brightness, a thickness of a graph, and a state of a line such as a solid line and a dotted line may be changed.

### Effect of Second Modification

As described above, in the present modification, the display data generating device 1 or the display data generating device 2 changes a drawing method of a graph in accordance with magnitude of a fluctuation in measurement value. In this way, the user can more intuitively determine a fluctuation in measurement value, which is suitable.

### Implementation Example by Software

Control blocks of the display data generating device 1 and the display data generating device 2 (the axis configuration unit 10 and the display data generating units 11 and 200) may be implemented by logic circuits (hardware) formed in integrated circuits (IC chips) and the like, or may be implemented by software.

In the latter case, the display data generating devices 1 and 2 can be achieved by a measurement program that is software for implementing each function and a computer that executes commands of the measurement program. The computer includes at least one processor (control device), for example, and includes at least one computer-readable recording medium storing the measurement program therein. In the computer, the processor reads out the measurement program from the recording medium and executes the measurement program, thereby accomplishing the object of the present embodiment. For example, a Central Processing Unit (CPU) may be used as the processor. As the recording medium, a “non-transitory tangible medium” such as a tape, a disk, a card, a semiconductor memory, and a programmable logic circuit may be used in addition to a Read Only Memory (ROM). Additionally, a Random Access Memory (RAM) on which the measurement program is loaded, or the like may be further provided. Further, the measurement program may be supplied to the computer via any transmission medium (communication network, broadcast wave, or the like) capable of transmitting the measurement program. Note that an aspect of the present invention may be implemented in a form of data signal embedded in a carrier wave, which is embodied by electronic transmission of the measurement program.

1. A display data generating device comprising:
an acquisition unit configured to sequentially acquire measurement data; and
a generating unit configured to generate display data,
wherein the generating unit is configured to
generate a plurality of two-dimensional graphs corresponding to a plurality of respective points in time, based on the measurement data acquired by the acquisition unit,
generate the display data by arranging, along a time series axis different from vertical and horizontal axes of each of the plurality of two-dimensional graphs, the plurality of two-dimensional graphs shifted by a width according to a time difference between points in time corresponding to adjacent two-dimensional graphs,
one of the vertical and horizontal axes represents a position on an object in a given direction, and
the other of the vertical and horizontal axes represents a measurement value about the object at the position.

2. The display data generating device according to claim 1,
wherein the generating unit generates a reference two-dimensional graph corresponding to at least one reference point in time, and a regular interval two-dimensional graph corresponding to a regular interval point in time with time put forward by a regular interval from each reference point in time within a range of not exceeding another reference point in time.

3. The display data generating device according to claim 2,
wherein, in a case where the acquisition unit does not acquire measurement data at the regular interval point in time, the generating unit generates a regular interval two-dimensional graph corresponding to the regular interval point in time, based on data interpolated from measurement data at a point in time around the regular interval point in time.

4. The display data generating device according to claim 3,
wherein, in a case where data is interpolated from measurement data at a point in time around the regular interval point in time, the generating unit does not use measurement data at a point in time configured across the reference point in time from the regular interval point in time.

5. The display data generating device according to claim 2,
wherein the generating unit configures the reference point in time, based on a change in the measurement data acquired by the acquisition unit.

6. The display data generating device according to claim 5,
wherein, in a case where the reference point in time is newly configured, the generating unit cancels the reference point in time that has already been configured, and also generates a second regular interval two-dimensional graph corresponding to a second regular interval point in time with time put back by a regular interval from the reference point in time that is newly configured.

7. The display data generating device according to claim 2,
wherein, in a case where two or more reference points in time are configured, the generating unit generates the two-dimensional graph corresponding to a range including at least two new reference points in time among the two or more reference points in time.

8. The display data generating device according to claim 1,
wherein the generating unit generates the display data such that the two-dimensional graph corresponding to a new point in time on the time series axis is preferentially displayed.

9. The display data generating device according to claim 1,
wherein the generating unit configures a different color for each two-dimensional graph according to data indicated by the two-dimensional graph.

10. A display data generating method comprising:
an acquisition step of sequentially acquiring measurement data by a display data generating device; and
a generating step of generating display data by the display data generating device,
wherein, in the generating step,
the display data generating device generates a plurality of two-dimensional graphs corresponding to a plurality of respective points in time, based on the measurement data acquired in the acquisition step,
the display data generating device generates the display data by arranging, along a time series axis different from vertical and horizontal axes of each of the plurality of two-dimensional graphs, the plurality of two-dimensional graphs shifted by a width according to a time difference between points in time corresponding to adjacent two-dimensional graphs,
one of the vertical and horizontal axes represents a position on an object in a given direction, and
the other of the vertical and horizontal axes represents a measurement value about the object at the position.

11. (canceled)

12. A computer-readable recording medium recording a program causing a computer to function as the display data generating device according to claim 1,
wherein the program causes a computer to function as the generating unit.
